(19) United States
(12) Patent Application Publication
(10) Pub. No.: US 2023/0342458 A1
(43) Pub. Date: Oct. 26, 2023

(54) TECHNIQUES TO MITIGATE CACHE-BASED SIDE-CHANNEL ATTACKS

(71) Applicant: Intel Corporation, Santa Clara, CA (US)

(72) Inventors: Marcel CORNU, Ennis (IE); Tomasz KANTECKI, Ennis (IE); John J. BROWNE, Limerick (IE)

(21) Appl. No.: 18/214,870

(22) Filed: Jun. 27, 2023

(51) Int. Cl. G06F 21/55; G06F 12/084

(52) U.S. Cl. CPC G06F 21/556; G06F 12/084; G06F 2212/1052

(57) ABSTRACT

Examples include techniques to mitigate or prevent cache-based side-channel attacks to a cache. Examples include use of assigned class of service (COS) assigned to cores of a process to determine whether to notify an OS of a potential malicious application attempting to access a cache line cached to a processor cache. Examples also include marking pages in an application memory address space of a processor cache as unflushable to prevent a potentially malicious application from accessing sensitive data loaded to the application memory address space of the processor cache.

### TECHNICAL FIELD

Examples described herein are generally related to mitigating cache-based side-channel attacks made against a cache hierarchy of a processor such as a central processing unit (CPU).

### BACKGROUND

A processor of a computing platform coupled to a network (e.g., in a datacenter) can be associated with various types of resources that can be allocated to an application, virtual machine (VM) or process hosted by the computing platform. The various types of resources can include, but are not limited to, central processing unit (CPU) cores, system memory such as random access memory, network bandwidth or processor cache (e.g., last level cache (LLC)). Performance requirements for the application that can be based on service level agreements (SLAs) or general quality of service (QoS) requirements can make it necessary to reserve or allocate one of more of these various types of resources to ensure SLAs and/or QoS requirements are met. One such resource allocation to the application can include allocated portions of a processor cache hierarchy to maintain cache line data for use during execution of an application workload.

### BRIEF DESCRIPTION OF THE DRAWINGS

FIG. 1 illustrates an example system.

FIG. 2 illustrates an example class of service (COS) map.

FIG. 3 illustrates an example first process flow.

FIG. 4 illustrates an example scheme.

FIG. 5 illustrates an example page attribute table.

FIG. 6 illustrates an example second process flow.

FIG. 7 illustrates example operating states of a computing platform.

FIG. 8 illustrates an example block diagram for a first apparatus.

FIG. 9 illustrates an example of a first logic flow.

FIG. 10 illustrates an example of a first storage medium.

FIG. 11 illustrates an example block diagram for a second apparatus.

FIG. 12 illustrates an example of a second logic flow.

FIG. 13 illustrates an example of a second storage medium.

FIG. 14 illustrates an example computing platform.

### DETAILED DESCRIPTION

Relatively new technologies such as Intel® Resource Director Technology (RDT) allow for monitoring usage and allocation of processor cache that is mainly focused on defining cache classes of service (COS or CLOS) and how to use bit masks such as capacity bitmasks (CBMs) to partition the processor cache to support the COS. In some implementations for these new technologies such as Intel® RDT, users can be able to use model specific registers (MSRs) directly to partition the processor cache to support the COS. In other implementations, users can use kernel support such as Intel® developed Linux kernel support or access software libraries to assist in partitioning the processor cache to support the COS. An application, VM or process hosted by the computing platform can then be assigned to a COS and this assignment can enable use (sometimes exclusive use) of partitioned portions of a processor cache hierarchy that can include, but is not limited to, level 2 (L2) cache, or level 3 (L3)/LLC cache. In addition to allocation of a processor cache hierarchy based on COS, memory attributes included in a page attribute table (PAT) can be used to dictate or indicate how applications can access and/or affect cache lines cached in a processor cache hierarchy.

Modern types of processors, such as but not limited to, Intel® Corporation or Advanced Micro Devices (AMD®) processors, can be vulnerable to cache-based timing attacks. For example, a FLUSH+RELOAD instruction attack where unprivileged malicious applications can effectively extract-sensitive information from a victim application by exploiting common operating system (OS) optimizations such as content-based page share (e.g., memory deduplication). Examples described in this disclosure can mitigate or eliminate some or possibly most types of cache-based side-channel attacks by generating an exception when a processor core executing a workload for an application attempts to access cache lines maintained in a cache hierarchy that is outside the processor core's assigned COS or by adding a new memory type to a PAT that makes specified memory pages of a potential victim application “unflushable” from a processor's cache hierarchy.

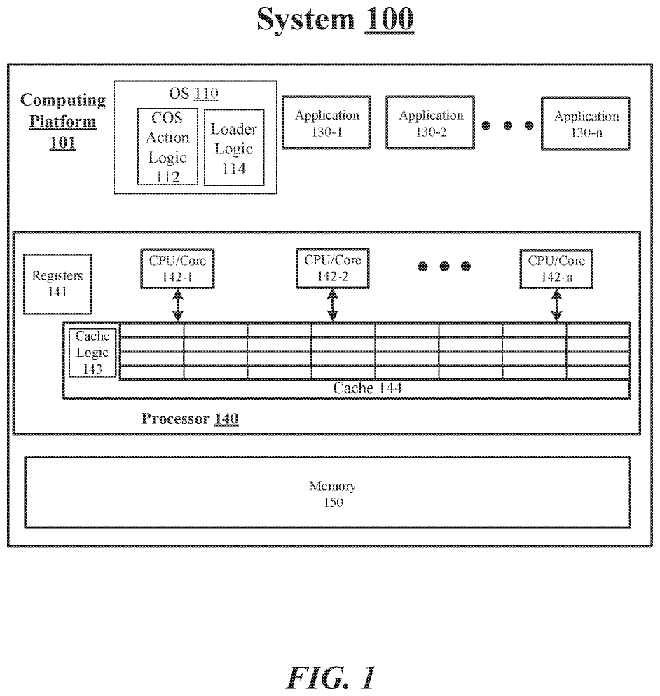

FIG. 1 illustrates an example system 100. In some examples, as shown in FIG. 1, system 100 includes a computing platform 101. For these examples, computing platform 101 can be coupled to a network (not shown) and can be part of a datacenter that includes a plurality of interconnected computing platforms, servers or nodes included in the datacenter. According to some examples, computing platform 101 can be a node composed of disaggregated resources (i.e., a node comprised of compute or accelerator resources hosted by a compute server or storage resources from a storage server in a datacenter to support applications 130-1 to 130-n, where “n” is any positive whole integer >1.

In some examples, as shown in FIG. 1, at least some of the composed computing resources for computing platform 101 can include processing elements such as CPU/cores 142-1 to 142-n having a cache 144. CPU/cores 142-1 to 142-n can have access to cache 144 to support execution of workloads for applications 130-1 to 132-n or OS 110 The access to cache 144 by CPU/cores 142-1 to 142-n can be allocated by OS 110 to various COS and the various COS can be assigned to applications 130-1 to 130-n for use to execute workloads that pull data from a larger system memory for computing platform 101 that can be included in memory 150. The partitioning of cache 144 can be based on, but is not limited to, such cache allocation technologies as Intel® Cache Allocation Technology (CAT). For example, Intel® CAT can use separate COS as a resource control tag via which applications 132-1 to 132-N or OS 111 can be grouped and each COS can in turn have associated resource capacity bitmasks (CBMs) indicating how much of cache 144 (e.g., number of cache ways) can be used in association with each COS. Cache 144 can include, but is not limited to, types of processor cache such L2 cache, and/or L3/LLC cache. Assigned CAT COS information can be programmed and/or maintained in registers 141. Registers 141 can include model-specific registers (MSRs) arranged to maintain assigned CAT COS information.

According to some examples, logic and/or features of OS 110 such as loader logic 114 can be arranged or configured to add a page attribute table (PAT) entry for an unflushable (UF) memory type to associate with memory included in cache 144 or memory 150 that can be used to at least temporarily store cache lines associated with application workload execution by CPU/cores 142-1 to 142-n. A PAT, for example, can be maintained and/or programmed in registers included in registers 141. The UF memory type, as described more below, can behave like a write back (WB) memory type, but certain instructions from an unprivileged application that can affect cache line placement can be ignored by a processor such as CPU/cores 142-1 to 142-n when the processor is not operating in a kernel mode (e.g., ring 0). For example, CLFLUSH, CLFLUSHOP, CLDEMOTE, CLWB instructions from unprivileged applications can be ignored by the processor if the instruction is to impact cache line placement to a memory address space of cache 144 that has been marked or identified as a UF memory type in the PAT maintained in registers included in registers 141.

As described in more detail below, circuitry, logic and/or features such as a cache logic 143 can be associated with and/or included in cache 144 (e.g., embodied in a cache controller) and can be configured to work in cooperation with logic and/or features of OS 110 such as a COS action logic 112. Cache logic 143 can be configured to generate an exception when a core attempts to access cache lines that are not tagged with a COS that matches its assigned CAT COS. COS action logic 112 can be arranged as a type of OS exception handler to enable OS 110 to take one or more corrective actions to mitigate a possible side-channel attack to cache 144 by a malicious application among applications 130-1 to 130-n.

In some examples, CPUs/cores 142-1 to 142-n can represent, either individually or collectively, various commercially available processors. The various commercially available processors can include, but are not limited to, processors designed to support or capable of supporting processor cache allocation technologies such as Intel® CAT including without limitation an Intel® Xeon® or Intel® Xeon Phi® processors or AMD64® Technology Platform Quality of Service Extensions for AMD® processors, or processors from other processor designers that implement similar processor cache allocation technologies.

According to some examples, cache 144 can include types of relatively fast access memory for CPUs/cores 142-1 to 142-n to minimize access latency. The types of relatively fast access memory included in cache 144 can include volatile or non-volatile types of memory. Also, memory 150 can include volatile or non-volatile types of memory, Volatile types of memory can include, but is not limited to, static random access memory (SRAM) or dynamic random access memory (DRAM), thyristor RAM (TRAM) or zero-capacitor RAM (ZRAM). Non-volatile types of memory can include byte or block addressable types of non-volatile memory having a 3-dimensional (3-D) cross-point memory structure that includes chalcogenide phase change material (e.g., chalcogenide glass) hereinafter referred to as “3-D cross-point memory”. Non-volatile types of memory can also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above.

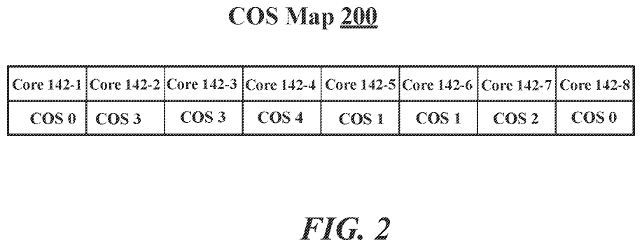

FIG. 2 illustrates an example COS map 200. In some examples, COS map 200 shows CAT COS assignments for 5 CLOS or COS for placement of cache lines to cache 144 of computing platform 101 shown in FIG. 1. Examples are not limited to 5 CLOS, fewer or more COS are contemplated by this disclosure. For these examples, as shown in FIG. 2, core 142-1 is assigned to COS 0, cores 142-5, 142-6 are assigned to COS 1, core 142-7 is assigned to COS 2, cores 142-2, 42-3 are assigned to COS 3 and core 142-4 is assigned to COS 4. Information related to COS map 200, for example, can be maintained in MSRs included in registers 141 of processor 140. According to some examples, cache lines to be placed in cache 144 can be tagged by logic and/or features of processor 140 such as cache logic 143 with an accessing core's assigned COS. The tag can be included in cache line metadata that is stored along with data to be accessed by a core executing an application workload. For example, the tag can be included in a portion of up to 64 kilobytes (KBs) of data included in a cache line to be placed in shared cache 144. Once a cache line is cached or placed in cache 144, any application from among applications 130-1 to 130-n or cores among cores 142-1 to 142-n can access the cache line cached to cache 144.

In some examples, as described in more detail below, a tag included in cache line metadata can be utilized to trigger a hardware interrupt/exception (e.g., by cache logic 143) when a core attempts to access a cache line that has a tag that indicates a different COS than is assigned to the core that is attempting to access this cache line. Logic and/or features of an OS (e.g., COS logic action 112) can then determine how to handle a potentially malicious access in order to mitigate a possible side-channel attack to a processor cache (e.g., cache 144).

According to some examples, at initial start-up or boot-up of a computing platform (e.g., computing platform 101), all cores/applications can be assigned to COS 0. For these examples, the use of cache line tags will have no effect since all cache lines belong to the same COS. Enabling the use of cache line tags can be done by setting a bit in a register (e.g., an MSR included in registers 141) and completing CAT COS assignments for at least a portion of the cores/applications. The bit can be set in the register, for example, based on a CPU identifier (CPUID) for the processor that identifies COS capabilities of the processor.

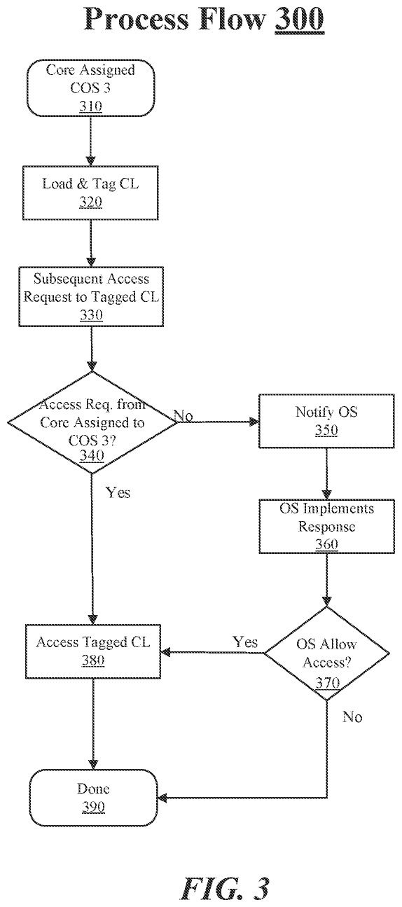

FIG. 3 illustrates an example process flow 300. In some examples, process flow 300 can represent a process flow to mitigate a possible side-channel attack to a shared processor cache such as cache 144 for processor 140. For these examples, elements of system 100 as shown in FIG. 1, can be related to process flow 300. These elements of system 100 can include elements of computing platform 101 such as COS action logic 112 of OS 110 and/or cache logic 143, cache 144 or memory 150. The elements of system 100 can also include applications 130-1 to 130-n supported by CPU/cores 142-1 to 142-n that utilize cache 144 to support these applications. COS map 200 shown in FIG. 2 can also be related to process flow 300. However, example process flow 300 is not limited to implementations using elements of system 100 shown in FIG. 1 and to COS map 200 shown in FIG. 2.

According to some examples, at 310, a core such as core 142-2 can be assigned COS 3. For these examples, OS 110 can assign COS 3 to core 142-2 as part of a CAT COS implementation to allocate portions of cache 144 to support applications 142-1 to 142-n.

In some examples, at 320, a core such as core 142-2 can cause a cache line to be loaded or placed in cache 144 at a memory address. For these examples, logic and/or features of processor 140 such as cache logic 143 can tag the cache line to indicate that core 142-2 has been assigned to COS 3. The tag can be indicated in metadata included in data of the cache line that is loaded to shared cache 144 at the memory address. The data of the cache line, for example, can be pulled from memory 150 and the metadata indicating COS 3 added to the data pulled from memory 150 to cause the cache line to be tagged with COS 3

According to some examples, at 330, a request to access the tagged CL that was tagged with COS 3 and stored to the memory address of cache 144 is made by a core from among cores 142-1 to 142-n. For these examples, the core can be the same core that caused the tagged cache line to be loaded to cache 144 or can be different core that was assigned COS 3 (e.g., core 142-3).

In some examples, at 340, logic and/or features of processor 140 such as cache logic 143 determines whether the core making the access request to the tagged CL has been assigned to COS 3. For these examples, cache logic 143 can refer to COS map 200 to determine the COS of the core requesting access. If the core has not been assigned to COS 3, process flow 300 moves to 350. If the core has been assigned to COS 3, process flow 300 moves to 380.

According to some examples, at 350, cache logic 143 determines that the access request is from a core that is not assigned to COS 3 (e.g., by referencing COS map 200) and this causes cache logic 143 to notify OS 110. For these examples, notification can include generation of or triggering a hardware interrupt/exception by cache logic 143 to indicate that a core has requested access to a tagged cache line for which the core's assigned COS does not match COS 3.

In some examples, at 360, OS 110 implements a response to the notification that a core has requested access to a tagged cache line for which the core's assigned COS does not match COS 3. Logic and/or features of OS 110 such as COS action logic 112 can handle a potentially malicious access depending on one or more OS configurations. COS action logic 112 response could range from mild to severe. Examples of responses can include, but are not limited to: (1) take no action, (2) monitor and log potentially illegal/unprivileged access(es) and potentially act later, (3) copy a memory page associated with the illegal/unprivileged access to the process address space for the application supported by the accessing core, or (4) generate a segmentation fault (segfault) or kill/stop the application supported by the accessing core. In some examples, CAT extensions such as code data prioritization (CDA) CAT extensions can be employed as well to define additional or different responses to be implemented by COS action logic 112.

According to some examples, if OS 110 determines to still allow access to the tagged CL, even though the accessing core's assigned COS does not match COS 3, process flow 300 moves to 390. If OS 110 determines to not allow access, process flow 300 moves to 390.

In some examples, at 380, based on either the core requesting access having an assigned COS matching COS 3 or being allowed by OS 110 to access the tagged CL even if the assigned COS does not match COS 3, the core is allowed to access the tagged CL.

In some examples, at 390, process flow 300 is done.

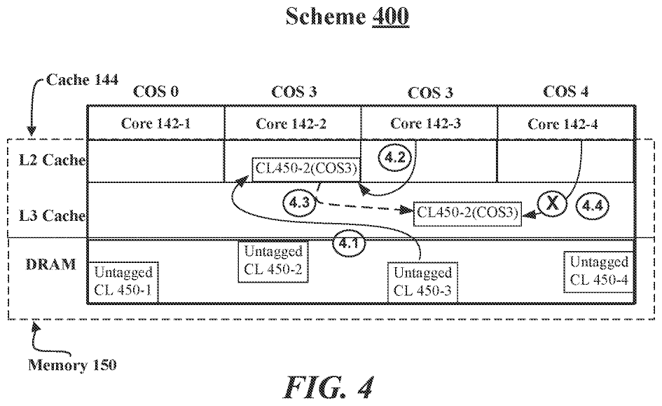

FIG. 4 illustrates an example scheme 400 related to process flow 300. Scheme 400 further illustrates a mitigation of a possible side-channel attack to cache 144. In some examples, as shown in FIG. 4, cache 144 includes an L2 cache and an L3 cache and memory 150 includes DRAM that can maintain a multitude of untagged cache lines (CLs) 450-1 to 450-n that include blocks of data. Examples are not limited to a cache that has two levels and to a memory that includes only DRAM.

According to some examples, at 4.1, core 142-3 causes data included in untagged CL 450-3 to be placed in L2 cache of cache 144 that has been allocated to core 142-2. As shown in FIG. 4, CL 450-3 is tagged with COS 3 to indicate core 142-3's assigned COS. As mentioned above the tag can be included in metadata added with the data from untagged CL 450-3.

In some examples, at 4.2, core 142-3 attempts to access tagged CL 450-3 while this tagged CL is still maintained in the L2 cache of cache 144. For these examples, since core 142-3 has been assigned the same COS 3, core 142-3 is allowed to access tagged CL 450-3.

According to some examples, at 4.3, tagged CL 450-3 is moved or placed in the L3 cache of cache 144. For example, tagged CL 450-3 can be evicted from the L2 cache based on a period of time in his L2 cache without any access requests, less frequent requests compared to other tagged cache lines maintained in the L2 cache, evicted due to a lower priority status compared to other tagged cache lines, or evicted due to any other type of cache eviction scheme.

In some examples, at 4.4, core 142-4 attempts to access tagged CL 450-3 and is blocked. For these examples, as mentioned above, cache logic 143 can notify OS 110 about an unprivileged access to a cache line and logic and/or features of OS 110 such as COS action logic 112 can take actions that effectively block core 142-4's access to tagged CL 450-3. Scheme 400 can then come to an end.

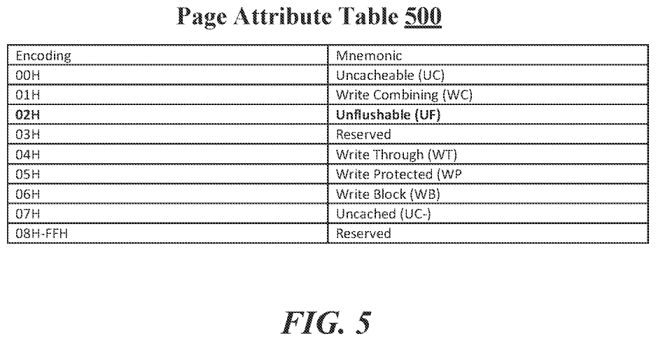

FIG. 5 illustrates an example page attribute table 500. In some examples, page attribute table 500 includes various memory type entries to allow for fine-grained control over how an area of memory such as cache 144 can be cached. Page attribute table 500 can be programmed to or maintained in registers 141 of processor 140. For example, programmed to or maintained in one or more MSRs included in registers 141 and/or maintained in a page table structure.

According to some examples, after a system such as system 100 boots up, an OS such as OS 110 can populate memory type entries for a page attribute table (PAT) that have encoding such as shown in FIG. 5. For these examples, a PAT entry for an unflushable (UF) memory type indicates hexadecimal encoding of 02H. The PAT entry for the UF memory type in page attribute table 500 can allow memory pages to use this memory type later. Applications/libraries (e.g., OpenSSL crypto library) can be marked as “sensitive” and executable program sections of these sensitive applications/libraries can have cached pages to a processor cache tagged or marked as an UF memory type via the 02H encoding. This can be done at runtime by exposing an application interface (API) for privileged users, or at compile time by adding an “unflushable” attribute to the executable program sections via the 02H encoding. Examples are not limited to a OpenSSL crypto library as an example of a type of “sensitive” application/library. Other types of “sensitive” applications/libraries can include, but are not limited to, financial data applications, password manager applications, healthcare data applications.

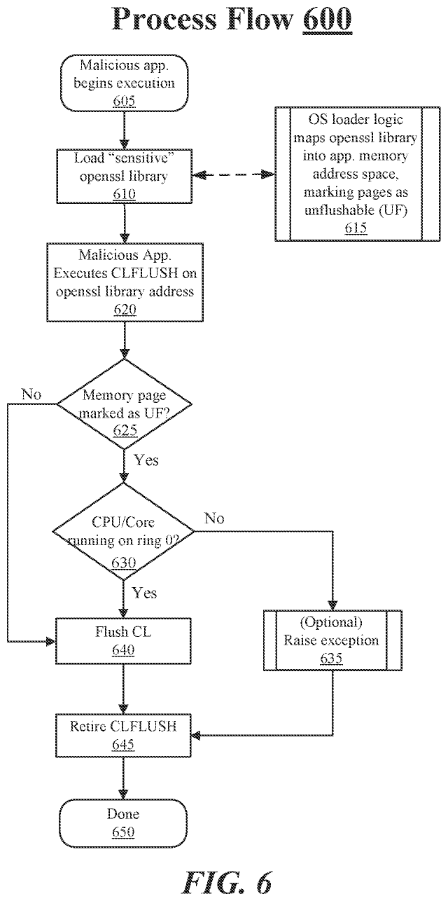

FIG. 6 illustrates an example process flow 600. In some examples, process flow 600 can represent another type of process flow to mitigate a possible side-channel attack to a shared processor cache such as cache 144 for processor 140. Mitigation, for example, can occur via use of an UF memory type for applications/libraries being tagged for use of the UF memory type to cache executable program sections to cache 144. For these examples, elements of system 100 as shown in FIG. 1, can be related to process flow 600. These elements of system 100 can include elements of computing platform 101 such as loader logic 114 of OS 110 and/or cache logic 143, cache 144 or memory 150. The elements of system 100 can also include applications 130-1 to 130-n supported by CPU/cores 142-1 to 142-n that utilize cache 144 to support these applications. Page attribute table 500 shown in FIG. 5 can also be related to process flow 600. However, example process flow 600 is not limited to implementations using elements of system 100 shown in FIG. 1 and to page attribute table 500 shown in FIG. 5.

According to some examples, at 605, a malicious application begins execution. For these examples, the malicious application can be designed to be used to flush/demote targeted cache lines in cache 144 to implement a flush-based side-channel attack that can leverage unprivileged instructions to affect cache line placement.

In some examples, at 610, the malicious/unprivileged application initiates loading of a “sensitive” OpenSSL library to its memory address space of cache 144.

According to some examples, at 615, logic and/or features of OS 110 such as loader logic 114 maps the OpenSSL library to the application memory address space of cache 144 and marks pages in this application memory address space as unflushable (UF). For example, loader logic 114 can mark or tag the application memory address space with the 02H encoding indicated in page attribute table 500 to tag the application memory address space with the UF memory type.

In some examples, at 620, the malicious application causes a CLFLUSH instruction to be executed on the application memory address space of cache 144 where the OpenSSL library was cached. Examples are not limited to CLFLUSH instructions. Other flush-related instructions can include, but are not limited to, CLFLUSHOP, CLDEMOTE or CLWB.

According to some examples, at 625, logic and/or features of processor 140 such as cache logic 143 determines whether the memory page that includes the OpenSSL library cached in cache 144 is marked as an UF memory type. For these examples, cache logic 143 can see if the 02H encoding has been programmed/encoded to the register associated with the application memory address space to determine if the memory page is marked as an UF memory type. If the register indicates that the memory page is marked as an UF memory type, process flow 600 moves to 630. Otherwise, process flow 600 moves to 640.

In some examples, at 630, if the CPU/core supporting the execution of the malicious application is running on ring 0, process flow 600 moves to 640. Otherwise, process flow 600 moves to 635. Not running on ring 0, means the CPU/core is operating on user space data.

According to some examples, at 635, logic and/or features of processor 140 such as cache logic 143 raises an exception due to the memory page being marked as an UF memory type and the CPU/core not running on ring 0. The exception can be optional based on whether or not OS 110 needs to be notified of a potential malicious application to possibly take further actions. In some examples, no exception needs to be raised and process flow 600 can move to 645.

In some examples, at 640, if cache logic 143 has determined that the memory page is marked as an UF memory type or the CPU/core is running on ring 0, the cache line that includes the memory page is flushed from cache 144.

According to some examples, at 645, the CLFLUSH instruction is retired by the CPU/core supporting the execution of the malicious application. For these examples, retiring the CLFLUSH instruction following determination that the memory page is marked as an UF memory type and the CPU/core is not running on ring 0 effectively causes cache logic 143 to ignore the instruction and hence block the malicious application from affecting cache placement of the memory page in cache 144.

In some examples, at 650, process flow 600 is done.

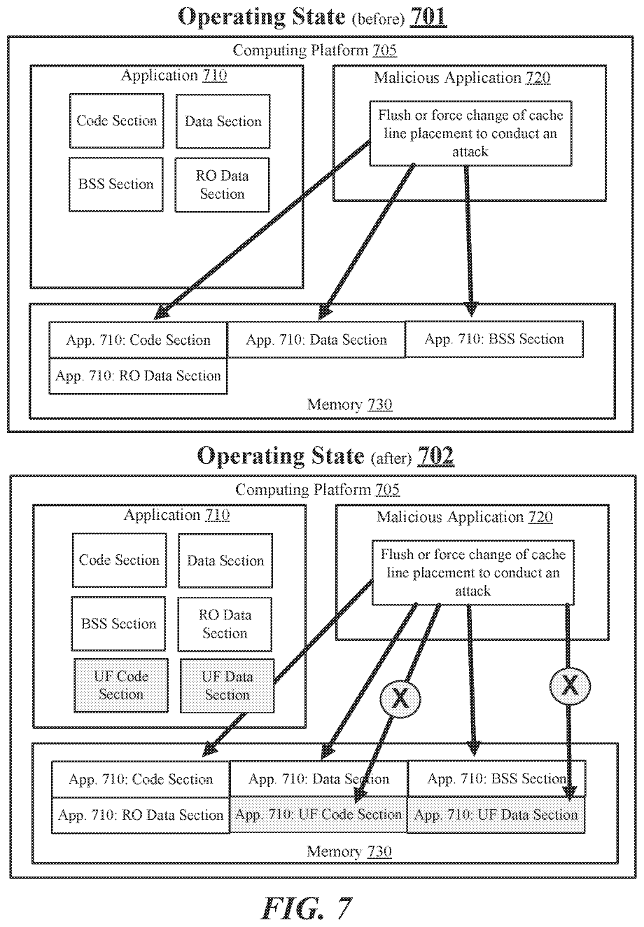

FIG. 7 illustrates an example operating states 701 and 702. In some examples, as shown in FIG. 7, a computing platform 705 can be in an operating state 701 before marking application memory address space as UF. For these examples, in operating state 701, application 710 has a code section, a data section, a block starting symbol (BSS) section and a read only (RO) section memory pages are cached to memory 730. Memory 730, for example, can represent memory included in a processor cache. As shown in FIG. 1, in operating state 701, since no memory pages have been marked as UF, malicious application 720 can cause a flush operation to flush or force a change of cache line placement to conduct a cache-based timing attack. However, in operating state 702, additional data for application 710's code section and data section memory pages can be marked as UF and as shown in FIG. 7, the circled X's indicate that any cache flush instructions instigated or caused by malicious application 720 to attempt to flush the UF code or UF data sections are blocked or retired without execution.

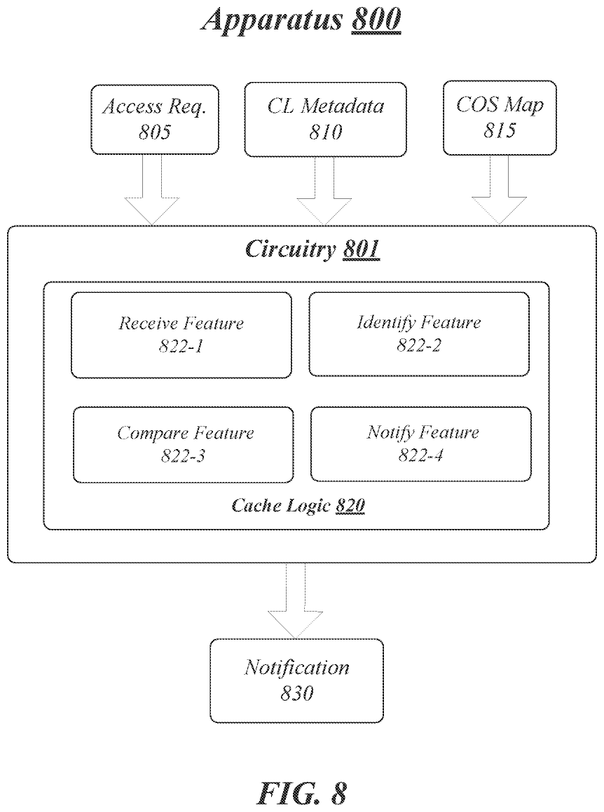

FIG. 8 illustrates an example block diagram for apparatus 800. Although apparatus 800 shown in FIG. 8 has a limited number of elements in a certain topology, it can be appreciated that the apparatus 800 can include more or less elements in alternate topologies as desired for a given implementation.

According to some examples, apparatus 800 can be supported by circuitry 801. For these examples, circuitry 801 can be at an application specific integrated circuitry (ASIC), field programmable gate array (FPGA), configurable logic, processor, processor circuit, CPU, or core of a CPU for a computing platform, e.g., computing platform 101 shown in FIG. 1. For these examples, the ASIC, FPGA, configurable logic, processor, processor circuit, CPU, or one or more cores of a CPU can support logic and/or features of a cache logic 820 arranged to operate similar to cache logic 143 to mitigate or prevent a side-channel attack to a shared processor cache such as cache 144 of processor 140 hosted by computing platform 101. Circuitry 801 can execute cache logic 820 and cache logic 820 can be arranged to implement one or more software or firmware implemented modules, components, or features 822-a (module, component, logic or feature can be used interchangeably in this context). It is worthy to note that “a” and “b” and “c” and similar designators as used herein are intended to be variables representing any positive integer. Thus, for example, if an implementation sets a value for a=4, then a complete set of software or firmware for modules, components or features 822-a can include features 822-1 to 822-4. The examples presented are not limited in this context and the different variables used throughout can represent the same or different integer values. Also, “logic”, “module”, “component” or “feature” can also include software/firmware stored in computer-readable media, and although types of logic or features are shown in FIG. 8 as discrete boxes, this does not limit these types of logic or features to storage in distinct computer-readable media components (e.g., a separate memory, etc.).

According to some examples, as mentioned above, circuitry 801 can include an ASIC, an FPGA, a configurable logic, a processor, a processor circuit, a CPU, or one or more cores of a CPU. Circuitry 801 can be generally arranged to execute cache logic 820. Circuitry 801 can be all or at least a part of any of various commercially available processors, including without limitation an AMD® EPYC® and Zen® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Core i9, Pentium®, Xeon®, Xeon Phi® and XScale® processors; and similar processors.

According to some examples, cache logic 820 can include a receive feature 822-1. Receive feature 822-1 can receive a request to access a cache line cached to the cache from a first core of a multi-core processor, the request to access the cache line for the first core to support execution of an application workload. For these examples, the request to access the cache line can be included in access request 805.

In some examples, cache logic 820 can include an identify feature 822-2. Identify feature 822-2 can identify a COS tagged to the cache line. For these examples, identify feature 822-2 can use metadata included in CL metadata 810 to identify what COS has been tagged to the cache line for the access request.

According to some examples, cache logic 820 can include a compare feature 822-3. Compare feature 822-3 can compare the COS tagged to the cache line to a COS assigned to the first core for the first core's use of the cache. For these examples, compare feature 822-3 can compare the COS identified by identify feature 822-2 with a COS map included in COS map 815.

In some examples, cache logic 822-2 can include a notify feature 822-4. Notify feature 822-4 can notify an OS if the COS tagged to the cache line does not match the COS assigned to the first core. For these examples, notification 830 can be sent to the OS and the OS can take no action, monitor a granted access to the cache, or generate a segmentation fault to stop execution of the application workload.

Various components of apparatus 800 and a device or node implementing apparatus 800 can be communicatively coupled to each other by various types of communications media to coordinate operations. The coordination can involve the uni-directional or bi-directional exchange of information. For instance, the components can communicate information in the form of signals communicated over the communications media. The information can be implemented as signals allocated to various signal lines. In such allocations, each message is a signal. Further embodiments, however, can alternatively employ data messages. Such data messages can be sent across various connections. Example connections include parallel interfaces, serial interfaces, and bus interfaces.

Included herein is a logic flow related to apparatus 800 that can be representative of example methodologies for performing novel aspects for mitigating or preventing a possible side-channel attack to a shared processor cache. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

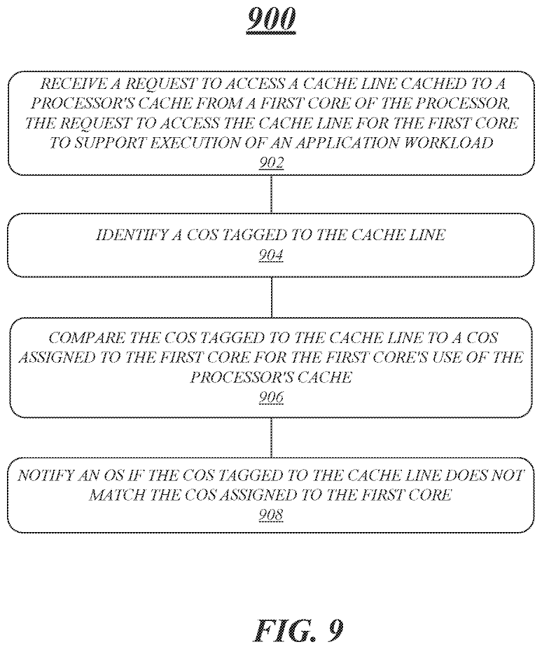

FIG. 9 illustrates an example logic flow 900. Logic flow 900 can be representative of some or all of the operations executed by one or more logic, features, or devices described herein, such as apparatus 800. More particularly, logic flow 900 can be implemented by at least receive feature 822-1, identify feature 822-2, compare feature 822-3, or notify feature 822-4.

According to some examples, logic flow 900 at block 902 can receive a request to access a cache line cached to a processor's cache from a first core of the processor, the request to access the cache line for the first core to support execution of an application workload. For these examples, receive feature 822-1 can receive the request.

In some examples, logic flow 900 at block 904 can identify a COS tagged to the cache line. For these examples, identify feature 822-2 can identify the COS.

According to some examples, logic flow 900 at block 906 can compare the COS tagged to the cache line to a COS assigned to the first core for the first core's use of the processor's cache. For these examples, compare feature 822-3 can make the comparison.

In some examples, logic flow 900 at block 908 can notify an OS if the COS tagged to the cache line does not match the COS assigned to the first core. For these examples, notify feature 822-4 can notify the OS.

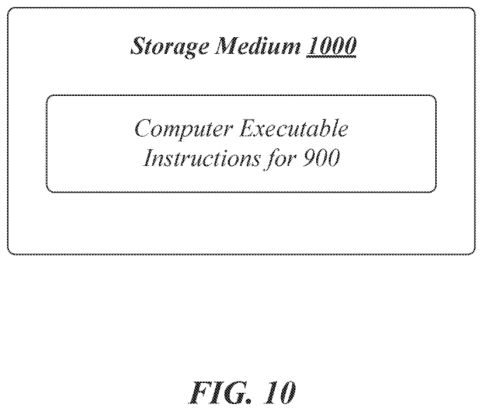

FIG. 10 illustrates an example storage medium 1000. As shown in FIG. 10, the first storage medium includes a storage medium 1000. The storage medium 1000 can comprise an article of manufacture. In some examples, storage medium 1000 can include any non-transitory computer readable medium or machine readable medium, such as an optical, magnetic or semiconductor storage. Storage medium 1000 can store various types of computer executable instructions, such as instructions to implement logic flow 900. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

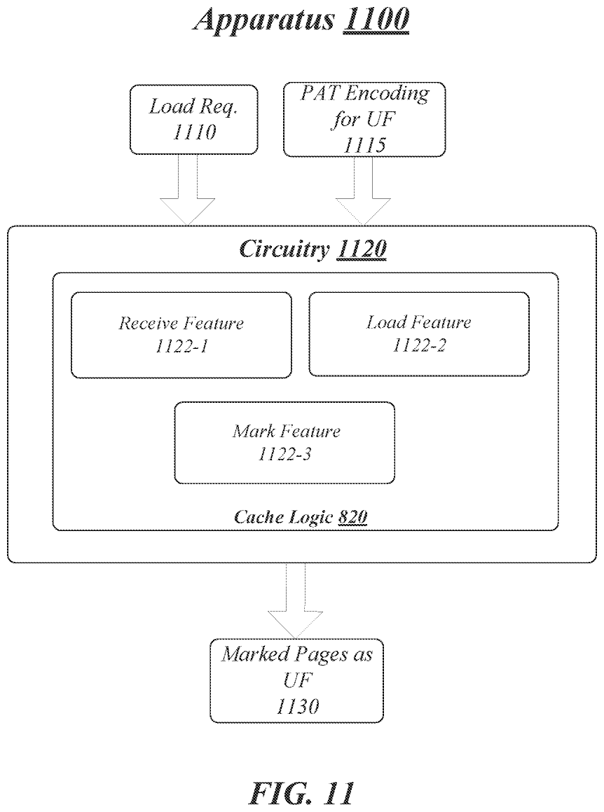

FIG. 11 illustrates an example block diagram for apparatus 1100. Although apparatus 1100 shown in FIG. 11 has a limited number of elements in a certain topology, it can be appreciated that the apparatus 1100 can include more or less elements in alternate topologies as desired for a given implementation.

According to some examples, apparatus 1100 can be supported by circuitry 1101. For these examples, circuitry 1101 can be at an ASIC, FPGA, configurable logic, processor, processor circuit, CPU, or core of a CPU for a computing platform, e.g., computing platform 101 shown in FIG. 1. For these examples, the ASIC, FPGA, configurable logic, processor, processor circuit, CPU, or one or more cores of a CPU can support logic and/or features of a loader logic 1120 arranged to operate similar to loader logic 114 to mitigate or prevent a side-channel attack to a shared processor cache such as cache 144 of processor 140 hosted by computing platform 101 (e.g., mitigate flush-based cache attacks). Circuitry 1101 can execute loader logic 1120 and loader logic 1120 can be part of an OS such as OS 110 of computing platform 101. Loader logic 1120 can be arranged to implement one or more software or firmware implemented modules, components, or features 1122-a (module, component, logic or feature can be used interchangeably in this context). It is worthy to note that “a” and “b” and “c” and similar designators as used herein are intended to be variables representing any positive integer. Thus, for example, if an implementation sets a value for a=3, then a complete set of software or firmware for modules, components or features 1122-a can include features 1122-1 to 1122-3. The examples presented are not limited in this context and the different variables used throughout can represent the same or different integer values. Also, “logic”, “module”, “component” or “feature” can also include software/firmware stored in computer-readable media, and although types of logic or features are shown in FIG. 11 as discrete boxes, this does not limit these types of logic or features to storage in distinct computer-readable media components (e.g., a separate memory, etc.).

According to some examples, as mentioned above, circuitry 1101 can include an ASIC, an FPGA, a configurable logic, a processor, a processor circuit, a CPU, or one or more cores of a CPU. Circuitry 1101 can be generally arranged to execute loader logic 1120. Circuitry 1101 can be all or at least a part of any of various commercially available processors similar to what was mentioned above for circuitry 801.

According to some examples, loader logic 1120 can include receive feature 1122-1. Receive feature 1122-1 can receive a request to load sensitive data to an application memory address space of a processor cache from an application. For these examples, the request can be included in load request 1110.

In some examples, loader logic 1120 can include a load feature 1122-2. Load feature 1122-2 can cause the sensitive data to load to the application memory address space of the processor cache.

According to some examples, loader logic 1120 can include a mark feature 1122-3. Mark feature 1122-3 can mark pages in the application memory address space as unflushable based on the sensitive data being loaded to the application memory address space. Marking the pages as unflushable causes any cache flush instructions received from the application to be ignored or retired. For these examples, mark feature 1122-3 can use an encoding indicated in PAT encoding for UF 1115 to mark the pages in the application memory address space as UF. The marked pages can be included in marked pages as UF 1130.

Various components of apparatus 1100 and a device or node implementing apparatus 1100 can be communicatively coupled to each other by various types of communications media to coordinate operations. The coordination can involve the uni-directional or bi-directional exchange of information. For instance, the components can communicate information in the form of signals communicated over the communications media. The information can be implemented as signals allocated to various signal lines. In such allocations, each message is a signal. Further embodiments, however, can alternatively employ data messages. Such data messages can be sent across various connections. Example connections include parallel interfaces, serial interfaces, and bus interfaces.

Included herein is a logic flow related to apparatus 1100 that can be representative of example methodologies for performing novel aspects for mitigating or preventing a possible side-channel attack to a shared processor cache. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

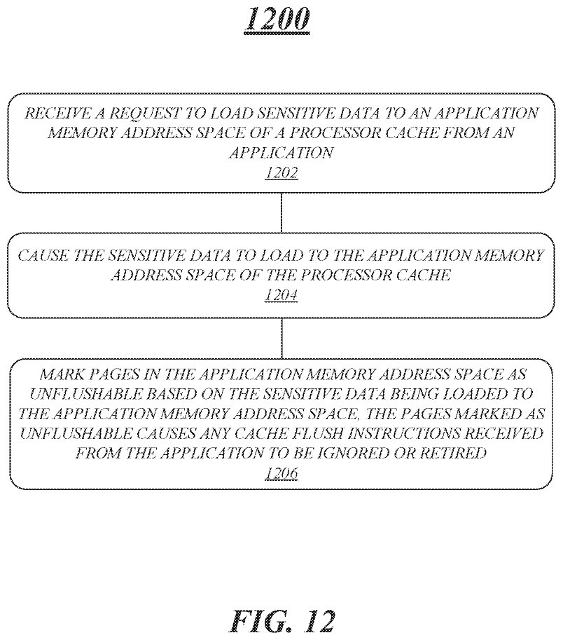

FIG. 12 illustrates an example logic flow 1200. Logic flow 1200 can be representative of some or all of the operations executed by one or more logic, features, or devices described herein, such as apparatus 1100. More particularly, logic flow 1200 can be implemented by at least receive feature 1122-1, load feature 1122-2, or mark feature 1122-3.

According to some examples, logic flow 1200 at block 1202 can receive a request to load sensitive data to an application memory address space of a processor cache from an application. For these examples, receive feature 1122-1 can request the request via load request 1110.

In some examples, logic flow 1200 at block 1204 can cause the sensitive data to load to the application memory address space of the processor cache. For these examples, load feature 1122-2 can cause the sensitive data to be loaded.

According to some examples, logic flow 1200 at block 1206 can mark pages in the application memory address space as unflushable based on the sensitive data being loaded to the application memory address space, the pages marked as unflushable causes any cache flush instructions received from the application to be ignored or retired. For these examples mark feature 1122-3 can mark the pages.

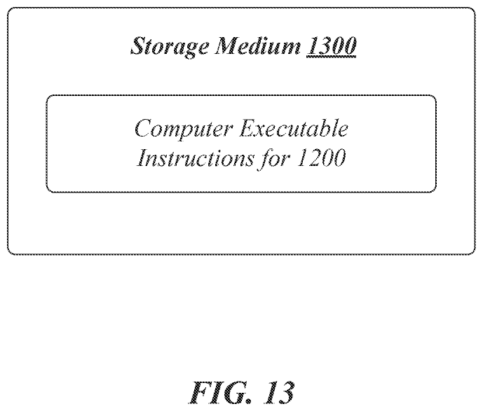

FIG. 13 illustrates an example storage medium 1300. As shown in FIG. 13, the first storage medium includes a storage medium 1300. The storage medium 1300 can comprise an article of manufacture. In some examples, storage medium 1300 can include any non-transitory computer readable medium or machine readable medium, such as an optical, magnetic or semiconductor storage. Storage medium 1300 can store various types of computer executable instructions, such as instructions to implement logic flow 1200. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

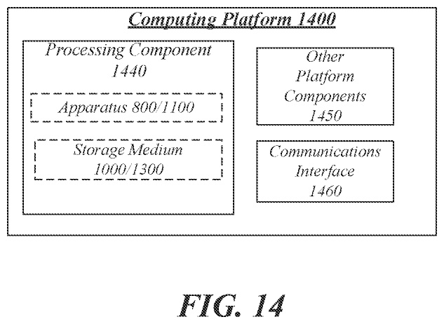

FIG. 14 illustrates an example computing platform 1400. In some examples, as shown in FIG. 14, computing platform 1400 can include a processing component 1440, other platform components 1450 or a communications interface 1460. According to some examples, computing platform 1400 can be similar to computing platform 101 shown in FIG. 1. Computing platform 1400 can be capable of coupling to a network and can be part of a datacenter including a plurality of network connected computing platforms.

According to some examples, processing component 1440 can execute processing operations or logic for apparatus 800/1100 and/or storage medium 1000/1300. Processing component 1440 can include various hardware elements, software elements, or a combination of both. Examples of hardware elements can include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements can include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1450 can include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays that can be locally or remotely coupled to computing platform 1400), power supplies, and so forth. Examples of memory units can include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), types of non-volatile memory such as 3-D cross-point memory that can be byte or block addressable. Non-volatile types of memory can also include other types of byte or block addressable non-volatile memory such as, but not limited to, multi-threshold level NAND flash memory, NOR flash memory, single or multi-level PCM, resistive memory, nanowire memory, FeTRAM, MRAM that incorporates memristor technology, STT-MRAM, or a combination of any of the above. Other types of computer readable and machine readable storage media can also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 1460 can include logic and/or features to support a communication interface. For these examples, communications interface 1460 can include one or more communication interfaces that operate according to various communication protocols or standards to communicate over direct or network communication links or channels. Direct communications can occur via use of communication protocols or standards described in one or more industry standards (including progenies and variants) such as those associated with the PCIe specification or the CXL specification. Network communications can occur via use of communication protocols or standards such those described in one or more Ethernet standards promulgated by IEEE. For example, one such Ethernet standard can include IEEE 802.3. Network communication can also occur according to one or more OpenFlow specifications such as the OpenFlow Hardware Abstraction API Specification.

As mentioned above computing platform 1400 can be implemented in a server of a datacenter. Accordingly, functions and/or specific configurations of computing platform 1400 described herein, can be included or omitted in various embodiments of computing platform 1400, as suitably desired for a server deployed in a datacenter.

The components and features of computing platform 1400 can be implemented using any combination of discrete circuitry, ASICs, logic gates and/or single chip architectures. Further, the features of computing platform 1400 can be implemented using microcontrollers, programmable logic arrays and/or microprocessors or any combination of the foregoing where suitably appropriate. It is noted that hardware, firmware and/or software elements can be collectively or individually referred to herein as “logic” or “circuit.”

It should be appreciated that the exemplary computing platform 1400 shown in the block diagram of FIG. 14 can represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example can be implemented by representative instructions stored on at least one machine-readable medium which represents various logic within the processor, which when read by a machine, computing device or system causes the machine, computing device or system to fabricate logic to perform the techniques described herein. Such representations, known as “IP cores” can be stored on a tangible, machine readable medium and supplied to various customers or manufacturing facilities to load into the fabrication machines that actually make the logic or processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples can include an article of manufacture or at least one computer-readable medium. A computer-readable medium can include a non-transitory storage medium to store logic. In some examples, the non-transitory storage medium can include one or more types of computer-readable storage media capable of storing electronic data, including volatile memory or non-volatile memory, removable or non-removable memory, erasable or non-erasable memory, writeable or re-writeable memory, and so forth. In some examples, the logic can include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium can include a non-transitory storage medium to store or maintain instructions that when executed by a machine, computing device or system, cause the machine, computing device or system to perform methods and/or operations in accordance with the described examples. The instructions can include any suitable type of code, such as source code, compiled code, interpreted code, executable code, static code, dynamic code, and the like. The instructions can be implemented according to a predefined computer language, manner or syntax, for instructing a machine, computing device or system to perform a certain function. The instructions can be implemented using any suitable high-level, low-level, object-oriented, visual, compiled and/or interpreted programming language.

Some examples can be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples can be described using the expression “coupled” and “connected” along with their derivatives. These terms are not necessarily intended as synonyms for each other. For example, descriptions using the terms “connected” and/or “coupled” can indicate that two or more elements are in direct physical or electrical contact with each other. The term “coupled” or “coupled with”, however, can also mean that two or more elements are not in direct contact with each other, but yet still co-operate or interact with each other.

The following examples pertain to additional examples of technologies disclosed herein.

Example 1. An example apparatus can include a cache and circuitry to execute logic. The circuitry can execute the logic to receive a request to access a cache line cached to the cache from a first core of a multi-core processor. The request can be to access the cache line for the first core to support execution of an application workload. The circuitry can also execute the logic to identify a COS tagged to the cache line. The circuitry can also execute the logic to compare the COS tagged to the cache line to a COS assigned to the first core for the first core's use of the cache. The circuitry can also execute the logic to notify an operating system if the COS tagged to the cache line does not match the COS assigned to the first core.

Example 2. The apparatus of example 1, the operating system, responsive to being notified, can take no action, monitor a granted access to the cache, or generate a segmentation fault to stop execution of the application workload.

Example 3. The apparatus of example 1, the COS tagged to the cache line not matching the COS assigned to the first core can indicate that the application workload is for a malicious application attempting a side-channel cache attack against the cache.

Example 4. The apparatus of example 1, to identify the COS tagged to the cache line can be based on metadata included with data in the cache line cached in the cache. The metadata can indicate a COS assigned to a second core of the multi-core processor. The data in the cache line can be cached to the cache for the second core to support execution of a second application workload.

Example 5. The apparatus of example 1, the cache can include an LLC shared by the first core and a second core of the multi-core processor.

Example 6. An example method can include receiving a request to access a cache line cached to a processor's cache from a first core of the processor. The request can access the cache line for the first core to support execution of an application workload. The method can also include identifying a COS tagged to the cache line. The method can also include comparing the COS tagged to the cache line to a COS assigned to the first core for the first core's use of the processor's cache. The method can also include notifying an operating system if the COS tagged to the cache line does not match the COS assigned to the first core.

Example 7. The method of example 6, the operating system, responsive to being notified, can take no action, monitor a granted access to the processor's cache, or generate a segmentation fault to stop execution of the application workload.

Example 8. The method of example 6, the COS tagged to the cache line not matching the COS assigned to the first core can indicate that the application workload is for a malicious application attempting a side-channel cache attack against the processor's cache.

Example 9. The method of example 6, identifying the COS tagged to the cache line can be based on metadata included with data cached in the cache line cached in the cache. The metadata can indicate a COS assigned to a second core of the processor. The data in the cache line that was cached to the processor's cache for the second core can support execution of a second application workload.

Example 10. The method of example 6, the processor's cache includes an LLC shared by the first core and a second core of the processor.

Example 11. An example at least one machine readable medium can include a plurality of instructions that in response to being executed by a system can cause the system to receive a request to access a cache line cached to a processor's cache from a first core of the processor. The request can be to access the cache line for the first core to support execution of an application workload. The instructions can also cause the system to identify a COS tagged to the and compare the COS tagged to the cache line to a COS assigned to the first core for the first core's use of the processor's cache. The instructions can also cause the system to notify an operating system if the COS tagged to the cache line does not match the COS assigned to the first core.

Example 12. The at least one machine readable medium of example 11, the operating system, responsive to being notified, can take no action, monitor a granted access to the processor's cache, or generate a segmentation fault to stop execution of the application workload.

Example 13. The at least one machine readable medium of example 11, the COS tagged to the cache line not matching the COS assigned to the first core can indicate that the application workload is for a malicious application attempting a side-channel cache attack against the processor's cache.

Example 14. The at least one machine readable medium of example 11, to identify the COS tagged to the cache line is based on metadata included with data cached in the cache line cached in the cache, the metadata to indicate a COS assigned to a second core of the processor, wherein the data in the cache line that was cached to the processor's cache for the second core to support execution of a second application workload.

Example 15. The at least one machine readable medium of example 11, the processor's cache can include an LLC shared by the first core and a second core of the processor.

Example 16. An example apparatus can include circuitry at a computing platform, the circuitry to execute logic. For this example, the circuitry can execute logic to receive a request to load sensitive data to an application memory address space of a processor cache from an application. The circuitry can also execute logic to cause the sensitive data to load to the application memory address space of the processor cache. The circuitry can also execute logic to mark pages in the application memory address space as unflushable based on the sensitive data being loaded to the application memory address space, marking the pages as unflushable can causes any cache flush instructions received from the application to be ignored or retired.

Example 17. The apparatus of example 16, to mark pages in the application memory address space can include using an encoding indicated in a page attribute table that indicates an unflushable memory type.

Example 18. The apparatus of example 16, to mark the pages as unflushable can cause any cache flush instructions received from the application to be ignored or retired is to mitigate or prevent a side-channel cache attack against the processor cache by the application to obtain the sensitive data.

Example 19. The apparatus of example 16, the sensitive data can include an OpenSSL library.

Example 20. The apparatus of example 16, the processor cache can include an LLC.

Example 21. An example method can include receiving a request to load sensitive data to an application memory address space of a processor cache from an application. The method can also include causing the sensitive data to load to the application memory address space of the processor cache. The method can also include marking pages in the application memory address space as unflushable based on the sensitive data being loaded to the application memory address space, marking the pages as unflushable can cause any cache flush instructions received from the application to be ignored or retired.

Example 22. The method of example 21, marking pages in the application memory address space can include using an encoding indicated in a page attribute table that indicates an unflushable memory type.

Example 23. The method of example 21, marking the pages as unflushable can cause any cache flush instructions received from the application to be ignored or retired is to mitigate or prevent a side-channel cache attack against the processor cache by the application to obtain the sensitive data.

Example 24. The method of example 21, the sensitive data can include an OpenSSL library.

Example 25. The method of example 21, the processor cache can include an LLC.

Example 26. An example at least one machine readable medium can include a plurality of instructions that in response to being executed by a system can cause the system to receive a request to load sensitive data to an application memory address space of a processor cache from an application. The instructions can also cause the system to cause the sensitive data to load to the application memory address space of the processor cache. The instructions can also cause the system to mark pages in the application memory address space as unflushable based on the sensitive data being loaded to the application memory address space, to mark the pages as unflushable can cause any cache flush instructions received from the application to be ignored or retired.

Example 27. The at least one machine readable medium of example 26, to mark pages in the application memory address space can include using an encoding indicated in a page attribute table that indicates an unflushable memory type.

Example 28. The at least one machine readable medium of example 26, to mark the pages as unflushable can cause any cache flush instructions received from the application to be ignored or retired is to mitigate or prevent a side-channel cache attack against the processor cache by the application to obtain the sensitive data.

Example 29. The at least one machine readable medium of example 26, the sensitive data can include an OpenSSL library.

Example 30. The at least one machine readable medium of example 26, the processor cache can include an LLC.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a cache; and
circuitry to execute logic to:
receive a request to access a cache line cached to the cache from a first core of a multi-core processor, the request to access the cache line for the first core to support execution of an application workload;
identify a class of service (COS) tagged to the cache line;
compare the COS tagged to the cache line to a COS assigned to the first core for the first core's use of the cache; and
notify an operating system if the COS tagged to the cache line does not match the COS assigned to the first core.

2. The apparatus of claim 1, wherein the operating system, responsive to being notified, is to take no action, monitor a granted access to the cache, or generate a segmentation fault to stop execution of the application workload.

3. The apparatus of claim 1, wherein the COS tagged to the cache line not matching the COS assigned to the first core indicates that the application workload is for a malicious application attempting a side-channel cache attack against the cache.

4. The apparatus of claim 1, to identify the COS tagged to the cache line is based on metadata included with data in the cache line cached in the cache, the metadata to indicate a COS assigned to a second core of the multi-core processor, wherein the data in the cache line was cached to the cache for the second core to support execution of a second application workload.

5. The apparatus of claim 1, wherein the cache includes a last level cache (LLC) shared by the first core and a second core of the multi-core processor.

6. A method comprising:
receiving a request to access a cache line cached to a processor's cache from a first core of the processor, the request to access the cache line for the first core to support execution of an application workload;
identifying a class of service (COS) tagged to the cache line;
comparing the COS tagged to the cache line to a COS assigned to the first core for the first core's use of the processor's cache; and
notifying an operating system if the COS tagged to the cache line does not match the COS assigned to the first core.

7. The method of claim 6, wherein the operating system, responsive to being notified, is to take no action, monitor a granted access to the processor's cache, or generate a segmentation fault to stop execution of the application workload.

8. The method of claim 6, wherein the COS tagged to the cache line not matching the COS assigned to the first core indicates that the application workload is for a malicious application attempting a side-channel cache attack against the processor's cache.

9. The method of claim 6, identifying the COS tagged to the cache line is based on metadata included with data cached in the cache line cached in the cache, the metadata to indicate a COS assigned to a second core of the processor, wherein the data in the cache line that was cached to the processor's cache for the second core to support execution of a second application workload.

10. The method of claim 6, wherein the processor's cache includes a last level cache (LLC) shared by the first core and a second core of the processor.

11. At least one machine readable medium comprising a plurality of instructions that in response to being executed by a system cause the system to:
receive a request to access a cache line cached to a processor's cache from a first core of the processor, the request to access the cache line for the first core to support execution of an application workload;
identify a class of service (COS) tagged to the cache line;
compare the COS tagged to the cache line to a COS assigned to the first core for the first core's use of the processor's cache; and
notify an operating system if the COS tagged to the cache line does not match the COS assigned to the first core.

12. The at least one machine readable medium of claim 11, wherein the operating system, responsive to being notified, is to take no action, monitor a granted access to the processor's cache, or generate a segmentation fault to stop execution of the application workload.

13. The at least one machine readable medium of claim 11, wherein the COS tagged to the cache line not matching the COS assigned to the first core indicates that the application workload is for a malicious application attempting a side-channel cache attack against the processor's cache.

14. The at least one machine readable medium of claim 11, to identify the COS tagged to the cache line is based on metadata included with data cached in the cache line cached in the cache, the metadata to indicate a COS assigned to a second core of the processor, wherein the data in the cache line that was cached to the processor's cache for the second core to support execution of a second application workload.

15. The at least one machine readable medium of claim 11, wherein the processor's cache includes a last level cache (LLC) shared by the first core and a second core of the processor.

16. At least one machine readable medium comprising a plurality of instructions that in response to being executed by a system cause the system to:
receive a request to load sensitive data to an application memory address space of a processor cache from an application;
cause the sensitive data to load to the application memory address space of the processor cache; and
mark pages in the application memory address space as unflushable based on the sensitive data being loaded to the application memory address space, wherein to mark the pages as unflushable causes any cache flush instructions received from the application to be ignored or retired.

17. The at least one machine readable medium of claim 16, wherein to mark pages in the application memory address space comprises using an encoding indicated in a page attribute table that indicates an unflushable memory type.

18. The at least one machine readable medium of claim 16, to mark the pages as unflushable to cause any cache flush instructions received from the application to be ignored or retired is to mitigate or prevent a side-channel cache attack against the processor cache by the application to obtain the sensitive data.

19. The at least one machine readable medium of claim 16, wherein the sensitive data comprises an OpenSSL library.

20. The at least one machine readable medium of claim 16, wherein the processor cache includes a last level cache (LLC).
